(19) United States
(12) Patent Application Publication
(10) Pub. No.: US 2023/0374352 A1
(43) Pub. Date: Nov. 23, 2023

(54) CHAOTIC NON-CONTINUOUS STRUCTURES USEFUL FOR FUNCTIONAL ADHESIVE SYSTEMS

(71) Applicant: 3M INNOVATIVE PROPERTIES COMPANY, St. Paul, MN (US)

(72) Inventors: Guy M. Kallman, Woodbury, MN (US); Sara Hemmer Frisco, Blaine, MN (US); Owen M. Anderson, Minneapolis, MN (US)

(21) Appl. No.: 18/126,805

(22) Filed: Mar. 27, 2023

Related U.S. Application Data
(62) Division of application No. 15/733,618, filed on Sep. 17, 2020, now abandoned.
(60) Provisional application No. 62/652,567, filed on Apr. 4, 2018.

(51) Int. Cl. C09J 7/38; C09J 7/24; B29C 59/04; B32B 7/12; B32B 27/06

(52) U.S. Cl. CPC C09J 7/385; C09J 7/245; B29C 59/04; B32B 7/12; B32B 27/06; C09J 2301/122; C09J 2301/302; C09J 2301/206; C09J 2427/006; C09J 2433/00

(57) ABSTRACT

A film-based article including a release liner having first and second major sides, a film layer having first and second major sides, an adhesive layer disposed between the first major side of the release liner and the second major side of the film, wherein the adhesive layer comprises a first surface adjacent to the second major side of the film, and a second surface adjacent to the first major side of the release liner. The second surface of the adhesive layer comprises an irregular array of channels.

### TECHNICAL FIELD

The present invention relates to film constructions having a structured adhesive pattern, and particularly related to multilayer films having a randomized, yet controlled pattern of microchannels.

### BACKGROUND

Film materials are widely available with graphics or a colored or transparent surface on one side and pressure-sensitive adhesive on the opposite side for application to a surface to change its appearance and/or performance characteristics. Bonding between the adhesive and the surface to which the film is applied can be impacted by a number of factors, including the type of adhesive used, the thickness and type of film material, the shape and contours of the surface to which the film material is applied, and the ability to properly position the film relative to the application surface.

One known way of providing some of these film properties involves the use of a pattern of channels in the adhesive surface that extend from one end or side of the film material to the other so that air bubbles can be pushed along those channels until they exit from channel ends that are open at one or both ends or sides of the film. Such a pattern typically includes channels that are arranged so that air bubbles can follow a continuous path along the channels until they exit at an edge of the film. In some cases, wide and deep channel patterns are used to provide relatively easy and effective air bleed or air removal paths. However, such products sometimes have a propensity to “backside imprint,” where the adhesive channels are visible as patterns or bumps on the top graphic side of the film. In other cases, the more pronounced patterns with the wide and deep channels can result in the channels collapsing when subjected to moist-dry cycles, which also impacts the visual quality of the products. On the other hand, dense/shallow channel patterns that are often less apt to exhibit backside imprinting generally provide for slower and more difficult air bleed or air removal during the film application process due to smaller air cavities that restrict the volumetric flow of trapped air. The reduced air flow can make the application of the material to a substrate more difficult.

The quality of the film application is important to providing an end project that is visually acceptable, particularly when the film is applied to a relatively large surface, as in the case of car wraps and fleet graphics. However, air or fluid entrapment between the film and the surface to which it is applied can be challenging to overcome, especially for larger surfaces or those with more complex contours. The time required during the installation process to bleed air or fluids and eliminate bubbles can be significant, depending on the properties of the film material. Additionally, if air or fluids are trapped beneath the film are not removed during the film application process, they can cause more significant visual defects after installation when the surface and the film are exposed to temperature changes and other environmental conditions. Although a skilled person applying the film can aid in addressing these issues, it is also beneficial to utilize a film that can initially be positionable and repositionable relative to its desired final location, adhered to the surface, and then be quickly and easily smoothed to eliminate bubbles between the film material and the surface to which it is applied.

### SUMMARY

The structured adhesive pattern and generation methodology provided herein is useful for applications where air removal, slide force, tackiness, backside imprinting, channel collapse, and peel strength are optimized with less compromise between these qualities. Film constructions provided herein provide for a desired compromise between these factors with the use of “chaotic” or randomized segments as opposed to continuous channel patterns that extend to the ends or sides of the film material.

In accordance with the film materials described herein, an embodiment of a film-based article comprises: a release liner having first and second major sides; a film layer having first and second major sides; an adhesive layer disposed between the first major side of the release liner and the second major side of the film, wherein the adhesive layer comprises a first surface adjacent to the second major side of the film, and a second surface adjacent to the first major side of the release liner, and wherein the second surface of the adhesive layer comprises an irregular array of channels; wherein the area covered by the channels is between approximately 5% and approximately 50% of the total surface area of the second surface of the adhesive layer according to the Adhesive Flat (Contact) Area test.

In accordance with the film materials described herein, an embodiment of a film-based article comprises a width, and the article comprises: a release liner having first and second major sides, wherein the first major side of the release liner comprises an irregular array of ridges; a film layer having first and second major sides; and an adhesive layer disposed between the first major side of the release liner and the second major side of the film, wherein the adhesive layer comprises a first surface adjacent to the second major side of the film, and a second surface adjacent to the first major side of the release liner, and wherein the second surface of the adhesive layer comprises an irregular array of channels that each comprise a channel length; wherein the average channel length is less than the width of the film-based article.

In accordance with the film materials provided herein, an embodiment of a film-based article comprises: a release liner having first and second major sides, wherein the first major side of the release liner comprises an irregular array of ridges; a film layer having first and second major sides; and an adhesive layer disposed between the first major side of the release liner and the second major side of the film, wherein the adhesive layer comprises a first surface adjacent to the second major side of the film, and a second surface adjacent to the first major side of the release liner, and wherein the second surface of the adhesive layer comprises an irregular array of channels that each comprise a channel volume; wherein the average channel volume is less than approximately 1.0 mm³/100 mm² of in-plane adhesive area. Such an area is described herein as the number of area units aligned with the plane of the web (e.g., per 10 mm×10 mm square section of material).

In accordance with the film materials provided herein, an embodiment of a film-based article comprises: a release liner having first and second major sides, wherein the first major side of the release liner comprises an irregular array of ridges; a film layer having first and second major sides; and an adhesive layer disposed between the first major side of the release liner and the second major side of the film, wherein the adhesive layer comprises a first surface adjacent to the second major side of the film, and a second surface adjacent to the first major side of the release liner, and wherein the second surface of the adhesive layer comprises an irregular array of channels that each comprise a channel length; wherein the irregular array of channels comprises at least a portion of one dead end per 100 mm² area.

In accordance with the film materials provided herein, an embodiment of a film-based article comprises: a film layer having first and second major sides; an adhesive layer comprising a first surface adjacent to the second major side of the film, and a second surface comprising an irregular array of channels; wherein the area covered by the channels is between approximately 5% and approximately 50% of the total surface area of the second surface of the adhesive layer according to the Adhesive Flat (Contact) Area test.

Film-based articles of the invention may be applied to a substrate using a method comprising the steps of: positioning a film-based article adjacent to an outer surface of a substrate, wherein the film-based article comprises: a release liner having first and second major sides; a film layer having first and second major sides; and an adhesive layer disposed between the first major side of the release liner and the second major side of the film, wherein the adhesive layer comprises a first surface adjacent to the second major side of the film, and a second surface adjacent to the first major side of the release liner, and wherein the second surface of the adhesive layer comprises an irregular array of channels. The method further includes removing the release liner from the second surface of the adhesive layer; and applying the second surface of the adhesive layer to the outer surface of the substrate.

Film-based articles described herein may be made by a method comprising the steps of: embossing a liner with an embossing roll that has air release feature pattern comprising an irregular array of channels, wherein the average channel length is less than the width of the embossing roll; coating an adhesive on the liner; and laminating the adhesive-coated liner to a film.

Alternatively, film-based articles described herein may be made by a method of making a film-based article, comprising the steps of: coating an adhesive to a flat liner; laminating the adhesive-coated flat liner to a film; embossing a second liner with an embossing roll that comprises an air release feature pattern comprising an irregular array of channels, wherein the average channel length is less than the width of the embossing roll; removing the flat liner from the adhesive; and laminating the flat liner to the second liner.

With the articles and methods described above, a number of additional features are contemplated, as will be summarized in the following paragraphs.

The first major side of the release liner may include an irregular array of ridges. The irregular array of channels of the second surface of the adhesive layer may correspond with the irregular array of ridges of the first major side of the release liner, wherein the first major side of the release liner may be releasably attached to the second major side of the adhesive layer. The irregular array of channels may include at least one of linear and curvilinear channel segments. The film layer may be at least one of optically clear, transparent, translucent, and colored.

The film layer may include at least one of vinyl, polyvinyl chloride, plasticized polyvinyl chloride, polyurethane (PU), polyethylene, polypropylene, fluororesin, polyethylene terephthalate (PET), polyethylene terephthalate glycol (PETG) polymethylmethacrylate (PMMA), polycarbonate (PC), and acrylonitrile butadiene styrene (ABS). The film layer may include multiple material layers, wherein at least one of the multiple material layers can be a primer material. The second surface of the adhesive layer can be in direct contact with the first major side of the release liner.

The irregular array of channels may include at least one channel having a depth that is the same as the depth of at least one additional channel, and/or may include at least one channel having a depth that is different from a depth of at least one additional channel. In addition, the irregular array of channels may include at least one channel having a length that is different than a length of at least one additional channel, and/or may include at least one channel having a length that is the same as the length of at least one additional channel.

Each channel of the irregular array of channels may intersect with at least one other channel of the irregular array of channels, and/or at least one channel of the irregular array of channels may intersect with at least two other channels of the irregular array of channels. Each intersection of multiple channels includes an intersection angle, wherein the irregular array of channels may include at least two different intersection angles over the first major side of the release liner.

Each channel of the irregular array of channels includes a first channel end and a second channel end, wherein neither of the first and second channel ends of at least one channel terminates at a first edge of the release liner. Alternatively, the irregular array of channels may be arranged to create at least one dead end.

The irregular array of channels may be arranged to create at least one area completely bounded by multiple channels on the first major side of the release liner, wherein the at least one area comprises multiple interior angles between channels, and wherein at least one of the interior angles is not equal to 90 degrees and/or at least one of the interior angles is different than at least one of the other interior angles.

With regard to the various channel configurations that are contemplated, one or a combination of the following features may be applicable to the irregular array of channels: the average channel length of the array of channels is less than approximately 10 mm; the average channel volume is less than approximately 1.0 mm³/100 mm² of in-plane adhesive area; the average channel length is less than at least one of a length and a width of the adhesive layer; the irregular array of channels comprises at least a portion of one dead end per 100 mm² area; and/or the total count of dead ends for each 100 mm² area is greater than zero and less than 500 according to the Adhesive Channel End Point Count test.

### BRIEF DESCRIPTION OF THE DRAWINGS

The present invention will be further explained with reference to the appended Figures, wherein;

FIG. 1 is a cross-sectional side view of an embodiment of a film-based article, illustrating three of its multiple channels;

FIG. 2 is a cross-sectional side view of the film-based article of FIG. 1, but with the release liner removed;

FIG. 3 is a plan view of an exemplary configuration of channels over an area of a film-based article;

FIG. 4 is a plan view of an exemplary configuration of channels similar to that of FIG. 3, but with thicker channels;

FIG. 5 a plan view of an exemplary configuration of channels over an area of a film-based article;

FIG. 6 is a plan view of an exemplary configuration of channels similar to that of FIG. 5, but with thicker channels;

FIG. 7 is a plan view of an exemplary pattern of channels for a single portion (at the left side of the figure) and three exemplary patterns “stitched” together in a row of channels;

FIG. 8 is a diagram showing an exemplary cross-section of a channel at its maximum depth as used for Examples 1 and 2;

FIG. 9 is a plan view of a channel layout used for Examples 1 and 2; and

FIG. 10 is a diagram showing an exemplary cross-section of a channel at its maximum depth as used for Examples 3 and 4.

### DETAILED DESCRIPTION

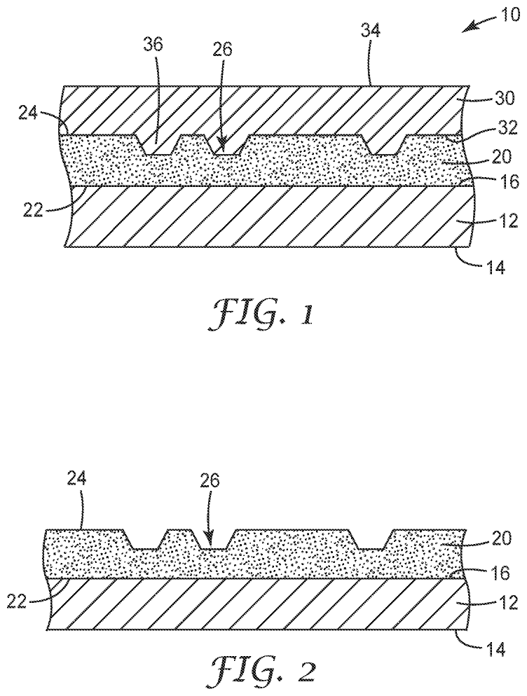

Referring now to the Figures, and initially to FIG. 1, an exemplary embodiment of a film material or film-based article 10 is illustrated, which generally includes: a film layer 12 having a first side 14 and a second side 16; an adhesive layer 20 having a first side 22 adjacent and bonded to the second side 16 of film layer 12, and an opposite second side 24; and a release liner 30 having a first side 32 releasably attached to the second side of adhesive layer 20, and a second side 34. The adhesive layer 20 is a pressure-sensitive adhesive that includes multiple channels 26 that are provided in a randomized or “chaotic” configuration to provide an irregular array of channels 26, as will be described below. The release liner 30 includes protrusions 36 extending outwardly from its first side 32, which are used to form the corresponding channels 26 in the adhesive layer 20.

The release liner 30 is used to protect the underlying adhesive layer 20 and its corresponding channels 26 at any time prior to application of the film-based article 10 to a substrate. The release liner 30 is partially or completely removable from the adhesive layer 20 so that the article 10 can be applied to a substrate.

Embodiments of the article provided herein include channels 26 that allow some degree of egress for air or fluid trapped between the adhesive and the surface of the substrate (not shown) to which the article 10 is applied. The channels 26 can be considered to create a microstructured surface which defines channels in a pressure sensitive adhesive with specific characteristics to allow for such an egress of air or fluid. As such, the channels in the adhesive of embodiments of the article provided herein have specific dimensions and characteristics to improve the positionability and air/fluid egress that includes channels or channel segments that do not necessarily terminate at the periphery of the film article.

Film layer 12 could be conformable or non-conformable, but preferably is a conformable or compliant film material with an elongation level of at least 50% and that includes one or more layers. As used herein, the term “conformable” generally refers to a film that can materially or completely take on the shape of a three-dimensional substrate containing convex features, concave features, and/or other shapes or contours. However, the determination of the conformability of a film is not limited to situations in which is it actually applied to such a substrate, but also that the film has this capability prior to being applied to a substrate. In some embodiments, taking on such shape is possible without undesired changes to the structural integrity and/or the aesthetic appearance of the film. In this sense, conformable films are distinguishable from non-conformable films that may be capable of being applied to planar surfaces and/or curved slightly around surfaces that have a sufficiently large radius of curvature (such as a large cylinder), but which are not possible to apply to (and conform to the surfaces of) a more complicated three-dimensional substrate.

Factors that can influence the conformability of a film include the identity of the material used to make the film, the molecular weight of such material, the conditions to which such film is subjected (e.g., temperature, radiation exposure, and humidity), and the presence of additives in the film material (e.g., plasticizer content, reinforcing fibers, pigments, stabilizers (e.g., UV stabilizers), and hardness enhancing particles).

The film layer utilized in embodiments of the article described herein is generally made of various plastic materials as will be understood by those skilled in the art. Suitable films include, for example, films that provide some optical property to the finished construction, such as reflected or transmitted color, opacity, retroreflectivity, clarity, diffusivity, print receptivity, printed images and patterns. Chemistries for the films in the 25 μm-250 μm (1-10 mil) range may include plasticized PVC films (both cast and calendared), urethanes, cellulosics, acrylics, olefins, polyesters and blends thereof. For example, films may include vinyl, polyvinyl chloride, plasticized polyvinyl chloride, polyurethane (PU), polyethylene, polypropylene, fluororesin, polyethylene terephthalate (PET), polyethylene terephthalate glycol (PETG) polymethylmethacrylate (PMMA), polycarbonate (PC), and acrylonitrile butadiene styrene (ABS). The film could be primed with an appropriate primer, such as a nitrogen rich polymer like an acrylic co-polymer, poly-amide or urethane. The primer may or may not be crosslinked via an appropriate chemistry such as epoxy, melamine or isocyanate. The film thickness can vary widely according to a desired application, but is usually within a range from about 300 μm or less, and preferably about 25 μm to about 100 μm. The film layer can be optically clear, transparent, translucent, and/or colored across its area.

Exemplary uses of the film-based articles described herein include vehicle wrap, medical tapes, graphic material for signage, structural tapes, and/or tapes for industrial and/or commercial applications, and the like. The film-based articles can vary in size, including both thickness and width, and can be applied to all or only a portion of a particular substrate.

A specific example of a suitable film layer is a plasticized polyvinyl chloride film, and has sufficient inelastic deformation after being stretched so that when stretched, the film does not recover to its original length. Preferably, the film has an inelastic deformation of at least 5% after being stretched once to 115% of their original length. A typical formulation of the vinyl film includes polyvinyl chloride resin, light and/or heat stabilizer(s), plasticizer, and optionally, pigment. The amount of plasticizer is generally less than about 40% by weight, and is preferably composed of polymeric non-migratable plasticizers which are compatible with the vinyl film and provide the necessary flexibility and durability. A suitable plasticizer is a combination of polymeric polyester elastomer and an ethylene vinyl acetate copolymer (such as Elvaloy 742 made by DuPont Co.) soluable in aromatic solvents and present in amounts of about 26 parts and 10 parts, respectively, per 100 parts vinyl resin.

Nonlimiting examples of film layers useful for the present invention may be thin or thick plastic (synthetic or natural), reflective sheeting, fabrics (woven or nonwoven), papers, metal foils, composite release liners and the like. The film may be constructed such that the resulting article is a graphic article, a transfer tape, a double-sided tape, an awning, and the like. Furthermore, the film may include additional functional and decorative layers, such as clear coats, decorative graphics, dirt and weather resistant coatings, art known adhesive layers, screen printable inks, barrier layers, adhesion promoters, multilayers of translucent films and the like. Such functional and decorative layers are known in the art and may be used, applied or laminated according to techniques known to those skilled in the art.

One or more primer layers may optionally be used to enhance the bond between the film layer and the adhesive layer. The type of primer will vary with the type of film and adhesive used and one skilled in the art can select an appropriate primer. Examples of suitable primer layers include chlorinated polyolefins, polyamides, and modified polymers disclosed in U.S. Pat. Nos. 5,677,376, 5,623,010 and those disclosed in WO 98/15601 and WO 99/03907, and other modified acrylic polymers. Typically, primers are dispersed into an adequate solvent in very low concentrations, e.g., less that about 5% solids, and coated onto the film, and dried at room or elevated temperatures to form a very thin layer. Typical solvents used may include water, heptane, toluene, acetone, ethyl acetate, isopropanol, and the like, used alone or as blends thereof

In accordance with embodiments of the film article, the pressure sensitive adhesive layer may include adhesives such as those that are capable of retaining microstructured features on an exposed surface after being embossed with a microstructured molding tool, backing or liner, or after being coated on a microstructured molding tool, backing or liner from which it is subsequently removed. The particular pressure sensitive adhesive selected for a given application is dependent upon the type of substrate to which the article will be applied and the microstructuring method employed in producing the adhesive-backed article. Additionally, useful microstructured pressure sensitive adhesives should be capable of retaining their microstructured surfaces for a time sufficient to allow utilization of the adhesive-backed article.

Many types of pressure-sensitive adhesives may be useful for the film-based article 10. The adhesive used can be selected based upon the type of substrate to which it will be adhered. Classes of pressure-sensitive adhesives include acrylics, tackified rubber, tackified synthetic rubber, ethylene vinyl acetate, silicone, and the like. Suitable acrylic adhesives are disclosed, for example, in U.S. Pat. Nos. 3,239,478, 3,935,338, 5,169,727, U.S. Pat. No. RE 24,906, U.S. Pat. Nos. 4,952,650, and 4,181,752. A preferred class of pressure-sensitive adhesives are the reaction product of at least alkyl acrylate with at least one reinforcing co-monomer. Suitable alkyl acrylates are those having a homopolymer glass transition temperature below about −10 degrees C. and include, for example, n-butyl acrylate, 2-ethylhexylacrylate, isoctylacrylate, isononlyl acrylate, octadecyl acrylate and the like. Suitable reinforcing monomers are those having a homopolymer glass transition temperature about −10 degrees C., and include for example, acrylic acid, itaconic acid, isobornyl acrylate, N,N-dimethylacrylamide, N-vinyl caprolactam, N-vinyl pyrrolidone, and the like.

The adhesive layer may comprise polymers that are dispersed in solvent or water and coated onto the release liner and dried, and optionally crosslinked. If a solvent-borne or waterborne pressure-sensitive adhesive composition is employed, then the adhesive layer generally undergoes a drying step to remove all or a majority of the carrier liquid. Additional coating steps may be necessary to achieve a smooth surface. The adhesives may also be hot melt coated onto the liner or microstructured backing. Additionally, monomeric pre-adhesive compositions can be coated onto the liner and polymerized with an energy source such as heat, UV radiation, e-beam radiation.

An exemplary method of making the film-based articles described herein includes the steps of embossing a liner with an embossing roll that has air release feature pattern, coating an adhesive on the liner, and laminating the adhesive-coated liner to a film. Another exemplary method of making the film-based articles described herein includes the steps of coating an adhesive to a flat liner, laminating the adhesive-coated flat liner to a film, embossing a second liner with an embossing roll that has air release feature pattern, removing the flat liner from the adhesive, and laminating the second liner with the embossed features to the adhesive.

The thickness of the adhesive is dependent upon several factors, including for example, the adhesive composition, the type of structures used to form the microstructured surface, the type of substrate, and the thickness of the film. Those skilled in the art are capable of adjusting the thickness to address specific application factors. In general, the thickness of the adhesive layer is greater than the height of the structures which comprise the microstructured surface. Preferably, the thickness of the adhesive layer is within a range from about 10 μm to about 50 μm.

The pressure sensitive adhesive can optionally include one or more additives. Depending on the method of polymerization, the coating method, the end use, etc., additives can be used that are selected from the group consisting of initiators, fillers, plasticizers, tackifiers, chain transfer agents, fibrous reinforcing agents, woven and non-woven fabrics, foaming agents, antioxidants, stabilizers, fire retardants, viscosity enhancing agents, coloring agents, and mixtures thereof

The irregular array of channels provided herein includes a randomized, yet controlled channel pattern that can provide higher volume channels and/or higher total channel volume per area without resulting in recognizable patterning on the visible side of the film. The irregular array can include a pseudo-random arrangement of channels, wherein the arrangement is created through use of a randomization algorithm, where the same seed will always provide the same arrangement of channels, ridges or features. However, the arrangement of channels is generally not recognizable to a human eye as repeating or having a regular pattern. The irregular array can include repetition of channel or ridge arrangements. For example, because a single engraving roll can be used to create a release liner having an irregular array of ridges, the particular array of ridges will repeat with a frequency consistent with the circumference of the engraving roll used to create the ridges. However, even in this scenario, the arrangement of channels or ridges is generally not detectable by a human eye as regular or recognizable pattern. It has been noted that randomized or chaotic configurations or patterns of channels are much harder to recognize on a surface of the film with the human eye then regular repeating patterns. As such, even if randomized patterns physically manifest themselves at least slightly on the visible side of the film, they will not be as readily recognizable with the human eye.

With the irregular arrays of channels or ridges described herein, the randomized channels do not necessarily extend from one peripheral edge of the film material to the other, thereby providing channels with a continuous path across the film with open ends at both edges of the material. Rather, in accordance with embodiments described herein, the channels are provided as segments that are shorter than the width and/or length of the film material, yet do allow for effective air removal.

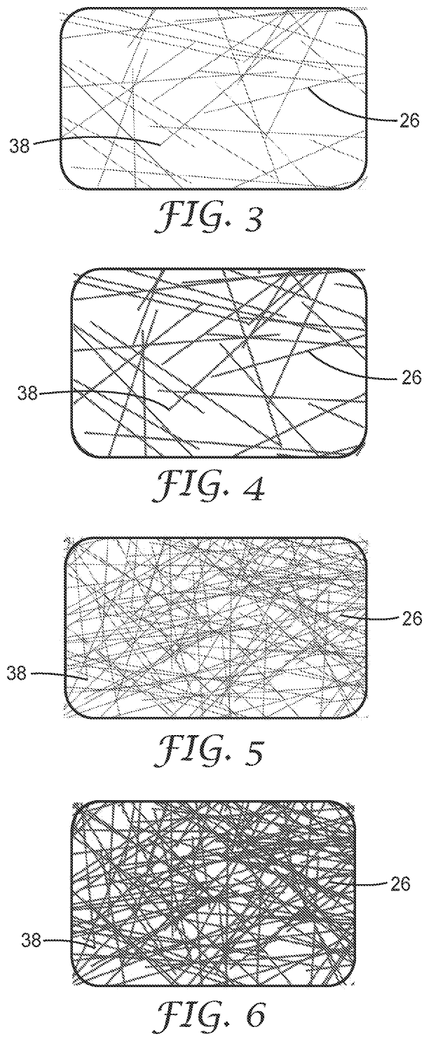

Referring now to FIGS. 3-6, several exemplary embodiments of randomized patterns of channels 26 are illustrated, which may also be referred to as an irregular array of channels. In the development of these configurations, physical attributes like an adhesive surface/groove ratio can be controlled while retaining what appears to be a generally randomized structure. Channel configurations can be developed in a number of manners, wherein one such approach includes developing an algorithm which allows for customization of the pattern while retaining a chaotic or randomization of the channels. By setting up a vector based model that varies groove length, pitch, and orientation, channels such as those in FIGS. 3-6 can be provided, wherein FIG. 3 provides for channels arranged with a ratio of the land/groove area of approximately 82%, while the same configuration with thicker channels is shown in FIG. 4 with a ratio of the land/groove area of approximately 53%. Similarly, the exemplary pattern of channels 26 of FIG. 5 includes a ratio of the land/groove area of approximately 91%, while the same configuration with thicker channels is shown in FIG. 6 with a ratio of the land/groove area of approximately 78%.

The configurations of FIGS. 3-6 are intended to be exemplary, in that a large variety of configurations can be provided that will lead to different product performance by changing a one or more parameters. It is contemplated that a customized algorithm is utilized to create the pattern, or that the randomized configurations can be created by brushing, blasting, or scratching the roll that creates the pattern, for example. That is, a number of attributes can be defined to provide certain types of channel patterns. Exemplary factors that can be considered in a channel design include the nominal segment length of the channels, the channel segment length dither, the channel segment pitch positioning, the pitch positioning dither, the nominal segment width of the channels, the orientation randomization granularity, the segment shape/type (e.g., canoe, continuous arch, feed trough, smooth, angled, curved, etc.), the nominal segment depth of the channels, the segment depth granularity, the land to groove ratio, the array resolution, and the like.

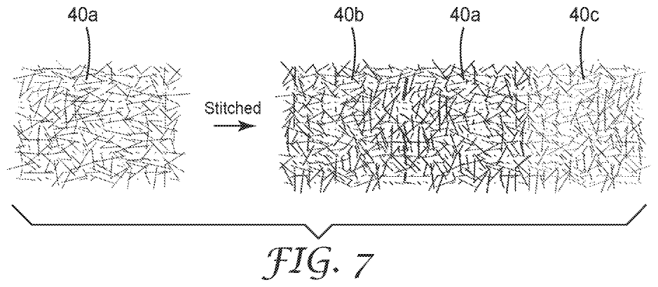

Along with the randomized or irregular array of segments provided in sections, patterns of channels can be “stitched” in one of the directions, allowing for larger sections to be built, as is illustrated in FIG. 7, for example. As shown, pattern 40a is a single area of randomized channels at the left of the figure, wherein additional patterns 40b and 40c are shown on opposite sides of pattern 40a at the right side of the figure. This stitching may be relatively difficult to detect considering that ‘mirroring’ and/or ‘sliding’ techniques are not as applicable for non-symmetric patterns.

A number of engraving methods for rolls used for the patterning can be used, including diamond cutting, direct etching and acid etching. The groove shape or structure can include many types of profiles, as were briefly mentioned above. For one example a “canoe like” profile would provide for a varying channel depth to allow air to ramp to the dead end represented by each segment. This structure would also be readily achievable for a diamond turning engraver.

By having distinct, “truncated” segments in the pattern of channels, groove geometries at the end of each segment can be designed to either encourage or discourage wet out (thus initial slide and/or tack) during the application process. For example, broad shallow ends can provide less initial contact area of the adhesive when lightly applied, thereby providing a product that is more easily slideable and/or removable upon application. Oppositely, deep, steep ends typically do not collapse as much, minimizing adhesion for a given initial adhesive contact area.

Patterns of channels of film-based article embodiments can include segments having one or more ends 38 (wherein one of such ends is labeled in each of FIGS. 3-6) that terminate within the area bounded by the peripheral edges of a sheet or roll of material. Those ends 38 of the channels are referred to herein as “dead ends” of the channels. In cases where a channel segment includes one dead end 38, the opposite end of the channel segment will terminate at one of the peripheral edges of the sheet or roll of material. In cases where a channel segment includes two dead ends 38, both ends of the channel segment terminate in the area bounded by the peripheral edges of the sheet or roll of material. In cases where a channel segment has opposite ends that both terminate at peripheral edges of the sheet or roll of material, the channel segment does not include any dead ends, in accordance with the description provided herein. The channels provided for a particular article can all be the same lengths, or can include at least one channel having a different length than the others. Similarly, the channels provided for a particular article can all have the same depth, or can include at least one channel having a different depth than the others. In some embodiments, the channels may include other configurations that have three or more dead ends, such as a “spider” or “centipede” configuration having multiple channel portions with dead ends extending from a central portion, or the channels can include configurations with intersecting or non-intersecting curves, circles, irregular shapes, and/or the like.

The multiple channels of the irregular channel arrays can be arranged in a large variety of configurations, wherein individual channels may or may not intersect with other channels. In an embodiment, at least one channel of the irregular array of channels intersects with at least one other channel of the irregular array of channels, wherein it is possible that all of the channels of an array intersect with at least one other channel, or even with two or more channels. With these intersecting channels, each intersection of multiple channels provides for an intersection angle, wherein the irregular array of channels comprises at least two different intersection angles over the first major side of the release liner. In an embodiment, the irregular array of channels is arranged to create at least one area completely bounded by multiple channels, wherein the bounded area comprises multiple interior angles between channels, and wherein at least one of the interior angles is not equal to 90 degrees. In a further embodiment, the bounded area comprises multiple interior angles between channels, wherein at least one of the interior angles is different than at least one of the other interior angles.

Channels or channel segments of embodiments provided herein can be linear, as shown in the figures, and/or may include other configurations of segmented or discrete structures including curved or curvilinear segments, overlapping and changing geometries like rings or squares, combinations of these various segments types, and the like.

The various film-based articles of the invention can be applied to a substrate using a variety of different methods, including the steps of positioning a film-based article adjacent to an outer surface of a substrate, wherein the film-based article comprises any of the many embodiments and variations thereof provided herein. The release liner is removed from a second surface of the adhesive layer and applying the second surface of the adhesive layer to the outer surface of the substrate.

In addition to the channel configurations described herein, the adhesive of the film-based articles may additionally be topologically microstructured in at least some areas. The microstructures can include a uniform distribution of adhesive pegs that protrude outward from the adhesive surface, such as those described by U.S. Pat. No. 5,296,277 to Wilson et al., incorporated herein by reference. The pegs can generally include the same adhesive material as the underlying adhesive layer and can have essentially flat tops. The pegs may be a composite of adhesive and beads or other materials. The microstructures generally permit weak initial tack of the sheet to a substrate, thus permitting easy repositioning as needed. The microstructures also make it possible to apply the sheet, such that a strong, permanent bond to the substrate is quickly established after pressure is applied to the sheet. The pegs provide repositionable adhesion with a light pressing on the adhesive sheet. Stronger adhesion can be made by compressing the pegs and contacting the underlying adhesive layer to the substrate.

### EXAMPLES

Objects and advantages of this invention are further illustrated by the following examples, but the particular materials and amounts thereof recited in these examples, as well as other conditions and details, should not be construed to unduly limit this invention. These examples are merely for illustrative purposes and are not meant to limit the scope of the claims.

Irregular channel structured adhesives were prepared. The physical and mechanical properties were evaluated as shown in the following examples. These examples are merely for illustrative purposes only and are not meant to be limiting on the scope of the appended claims. All parts, percentages, ratios, etc. in the examples and the rest of the specification are by weight, unless noted otherwise. Solvents and other reagents used were obtained from Sigma-Aldrich Chemical Company, St. Louis, Missouri unless otherwise noted. The following abbreviations are used herein: gm=grams; kg=kilograms; mm=millimeters; cm=centimeters; um=micrometers; in=inch; mL=milliliter; min=minute; sec=second; psi=pounds per square inch; RH=relative humidity; ° F. =degrees Fahrenheit; ° C. =degrees centigrade. The terms wt %, and % by weight are used interchangeably.

TABLE 1
Materials

| Abbreviation | Description |
|---|---|
| A1 | An acrylic pressure sensitive adhesive solution (described |
| | as Adhesive Solution 1 in U.S. Pat. No. 5,296,277 |
| | (Wilson et al.) and containing 0.15 parts of bis amide and |
| | 16 parts of tackifier) prepared at a solids content of |
| | 38.5%. The tackifier used was Terpene Phenol, available |
| | from Kraton Corporation Houston, TX as “SYLVARES” |
| | TP2019 |
| L1 | Particle filled, Embossed Release Liner as described in |
| | U.S. Pat. No. 5,296,277 (Wilson et al.), column 11, table |
| | 1 with surface depressions of 7225/in² at a density of 85 |
| | lines per inch. |
| V1 | Graphic Film, available from 3M Company, St. Paul, MN |
| | as 3M Print Wrap Film IJ180mc-10 |
| V2 | Graphic Film, available from 3M Company, St. Paul, MN |
| | as 3M Print Wrap Film IJ180C-10 |
| F1 | A cast, opaque, white PVC film with a thickness of 51 |
| | micrometers with a 0.5-1.0 micrometer thick layer of |
| | primer |

### Test Methods

### Dented Panel Trapped Air Removal Test

A circular indent was made in the center of a 15.2 cm×15.2 cm×0.76 mm thick aluminum test panel with an inside section flat and coplanar to a surrounding flange section.

The diameter of the circular indented was 43 mm and 1.4 mm deep. The indent was centered within a larger 53 mm diameter circle at the primary plane of the panel. A 15.2 cm×15.2 cm test sample was centered over the indent and applied flat onto the panel and taut over the indent. A hand applicator squeegee (available as PA-1 from 3M Company St. Paul, MN) with a low friction sleeve (available as SA-1 from 3M Company St. Paul, MN) was used to hand laminate the sample onto the panel using about 2 kg of force to give a flat uniform surface.

The film was then pressed with a thumb into the indent, by using just enough pressure at the center of the indent to make contact, then circulating the thumb with concentric rings working outward to force contact between the film and the full indent. The ability of the sample to conform into and uniformly contact the indent was rated as follows.

Level 0: Sample could be pressed down to conform swiftly (less than 30 seconds) and completely into the indent

Level 1: Sample could be pressed down to conform slowly (greater than 30 seconds) and completely into the indent

Level 2: Sample could be mostly pressed down, while leaving small air pockets

Level 3: Sample would not conform significantly into the indent against the entrapped air.

### Back Side Pattern Imprinting Test

Films with mechanical structures (grooves, channels, ridges, bumps, etc.) built into their adhesives typically telegraph these same structures to the opposite side of the film. In order to assess the degree of noticeable telegraphing of the underlying structure, a ranking system was setup for evaluation. First a 5.1 cm×7.6 cm sample film with patterned adhesive was laminated to a flat microscope slide 5.1 cm×7.6 cm using a hand applicator squeegee (available as PA-1 from 3M Company St. Paul, MN) with a low friction sleeve (available as PA-1 from 3M Company St. Paul, MN) with about 2 kg force at room temperature. After lamination, it was assessed for degree of adhesive backside imprinting using 3 lighting conditions.

Directional Light: A directional light source (available as HI-INT Illuminator, Model #1174 from Roxter Lighting Long Island City, NY) which projects light forward and primarily in one direction, was directed from approximately 45 cm onto the sample.

Diffuse Light: A wide area light panel (available as X-Ray Film View Panel #402481, 35 cm×41 cm from Picker) emitting light equally in all directions, was setup such that the sample was observed after placing the light panel on edge and putting the sample 25 cm from the emitting face of the panel.

Indirect Image: While observing a directionally lit sample (See directional lighting above) the observer moved such that the image of the bulb and surrounding lighting apparatus was assessed as to how well the image could be seen in the plane of the sample. For example highly glossy surfaces image well, low gloss samples do not image well.

For the three lighting conditions described above, the observer looked at the sample from approximately 75 cm, moving to varying observation angles.

The sample was given a rating as follows:

Level 0: Sampled show no backside variation under directional and diffuse light and indirect light imaging. Sample was similar in look as to what it would be without structured adhesive.

Level 1: Sample showed some backside variation under directional and/or indirect imaging. No variation viewable under diffuse lighting.

Level 2: Sample showed backside variation under all three conditions.

### Back Side Pattern Recognition Test

Films with mechanical structures (grooves, channels, ridges, bumps, etc.) built into their adhesives typically telegraph these same structures to the opposite side of the film. In order to assess the degree of noticeable and patterned telegraphing of the underlying structure, a pass/fail system was setup for evaluation. First a 5.1 cm×7.6 cm sample film with patterned adhesive was laminated to a flat microscope slide 5.1 cm×7.6 cm using a hand applicator squeegee (available as PA-1 from 3M Company St. Paul, MN) with a low friction sleeve (available as PA-1 from 3M Company St. Paul, MN) with about 2 kg force at room temperature. After lamination, it was assessed as to whether or not a pattern could be observed on the backside (PVC film side) under a point source of light. In this test the sample was laid down horizontally with a dimmed point source pointed at the surface from approximately 10 cm while observing the reflection off the surface from approximately 60 cm, behind and to the side of the light source (i.e. observing the image of source on the surface). The point source used was an iPhone 8 with its LED light turned on and pointed at the sample. Further, a 2.0 neutral density filter was held over the light (From Edmond Scientific, Part #83621410, 1″ Diameter) to reduce glare and enhance the surface image. The pattern was assessed as follows.

PASS: No recognizable repeat pattern observed on the backside while reviewing the sample.

FAIL: Repeat patterns are observed which correspond to the patterning in the adhesive. This includes geometric shapes such as squares, diamonds, channels, ridges and other geometric patterns.

### Adhesive Channel Length Test

An optical microscope (available as VHX-5000 from Keyence Corporation of America Palatine, IL) was used to assess and measure mean length of individual channels in the adhesive. Samples were prepared by first sputter coating the adhesive surface using a benchtop coater from Denton (Model: Denton Desk V TSC). The target used was Gold set at 60% power level for 90 seconds while saturating the chamber with Argon Gas. Once the adhesive surfaces were coated they were observed at 50×(6560 um×4920 um field of view) under Coaxial lighting conditions (brightfield). Using the linear measurement software tool, 20 representative channels were selected and measured for length. The mean of these 20 measurements were then reported as the Average Adhesive Channel Length (um).

### Adhesive Channel End Point Count Test

An optical microscope (available as VHX-5000 from Keyence Corporation of America

Palatine, IL) was used to assess and count the number of channel endpoints per unit area in the adhesive. Samples were prepared by first sputter coating the adhesive surface using a benchtop coater from Denton (Model: Denton Desk V TSC). The target used was Gold set at 60% power level for 90 seconds while saturating the chamber with Argon Gas. Once the adhesive surfaces were coated they were observed at 100×(3234 um×2422 um field of view) under coaxial lighting conditions (brightfield). Using the count tool, endpoints of channel segments were counted and reported for 4 different (3234 um×2422 um) areas. Only endpoints that terminated into the adhesive were counted. Endpoints that terminated into other channels were not counted. The average for the 4 areas was then scaled to end point count per 100 mm².

### Adhesive Flat (Contact) Area Test

An optical microscope (available as VHX-5000 from Keyence Corporation of America Palatine, IL) was used to assess and report the adhesive area prior to application that is flat and void of channels and/or surface non-sticky posts. Samples were prepared by first sputter coating the adhesive surface using a benchtop coater from Denton (Model: Denton Desk V TSC). The target used was Gold set at 60% power level for 90 seconds while saturating the chamber with

Argon Gas. Once the adhesive surfaces were coated they were observed at 30×(11 mm×8.3 mm field of view) under ring lighting conditions (darkfield). Using the Measure Area software option, the ratio of flat area to total area was assessed. Thresholding was set based on brightness and set such that the channel features remain intact while the flat area was highlighted by the software. Once processing took place, the software presented the highlighted area as a percentage of the total area, which was reported as Flat Area %. Channel Area is reported as 100% minus Flat Area %.

### Adhesive Channel Volume Measurement Test

A white light interferometer (available as the Contour GT with VISION64 operating and analysis software from Bruker) was used to assess and report the adhesive air channel volume prior to application. Samples were prepared by first sputter coating the adhesive surface using a benchtop coater from Denton (Model: Denton Desk V TSC). The target used was Gold set at 60% power level for 90 seconds while saturating the chamber with Argon Gas. Once the adhesive surfaces were coated they were observed using a 5× lens with multiple images stitched together to form a 4 mm×4 mm surface topography used for evaluation. The following procedure was then used to process the surface for channel (air) volume:

Use Mask Data function and setup 2 mm×2 mm lower left quadrant as active.

Use Terms Removal for Curvature and tilt.

Use Data Restore with iterations at 20.

Use Volume function.

Move threshold slider until flat area just disappears from image.

Using reported volume for that area assessed (2 mm×2 mm) calculate volume/area as mm³/100 mm² of in-plane adhesive area.

Repeat 1-6 for the three other quadrants.

Report average of all for quadrants in mm³/100 mm²

### Wet Out—Channel Length Test

A 2.5 cm×6.4 cm sample was applied to a standard 2.5 cm×7.6 cm clear microscope slide using a hand roller weighing 2kg with no additional force and in one pass. Samples were pre-conditioned at 72° F. at 50% RH for 24 hours before application to the slide. Samples were then assessed using an optical microscope (described above) for length of channels not wetting out (not making intimate contact with the glass, leaving an air pocket) onto the glass by observing the adhesive-glass interface through the slide using the optical microscope. This was done by individually measuring six different adhesive channels and reporting the mean length in units of microns.

### Wet Out— Adhesive Contact Area Test

A 2.5 cm×6.4 cm Sample was applied to a standard 2.5 cm×7.6 cm clear microscope slide using a hand roller weighing 2 kg with no additional force and in one pass. Samples were pre-conditioned at 72° F. at 50% RH for 24 hours before application to the slide. Samples were then assessed for area that was in intimate contact with the glass by observing the adhesive-glass interface through the slide using an optical microscope (as described above). Wetout Adhesive Contact Area is expressed as a ratio of Wet Out Area/Total observation area. Wet Out Area was obtained by using the optical microscope in brightfield lighting mode and using the Measure Area software option. Thresholding was set based on brightness and set such that the channel features remain intact while the Wet Out Area (intimate contact area between adhesive and slide) was highlighted by the software. Once processing took place, the software presented the highlighted area as a percentage of the total area, which was reported.

### Adhesive Airflow Test

To measure and assess airflow through the channels imparted into the adhesive, a test was developed such that a sample 17.8 cm×17.8 cm was laminated onto a metal plate (15.2 cm×20.3 cm). Two concentric rings are imparted and positioned generally in the middle of the metal plate. The outer ring is 1.3 cm from the left, right, and bottom edges of the metal plate, and 6.4 cm from the top edge of the metal plate. The outer ring (12.7 cm diameter) supplies air pressure at 99.6 K dynes/cm\hat{ }2 (40 in/H2O) and the inner ring (10.2 cm diameter) vents into a flow meter (Gilmont Accucal, Model GF-6540-1200) to assess the flow of air through the adhesive channels from the outer ring to the inner ring. The ring channel dimension was 0.8 mm deep by 1.0 mm wide.

The sample was placed such that it was centered on the rings, leaving three edges over-hanging the plate edges. It was then laminated onto the plate and across the rings using a 7.6 cm face×6.4 cm diameter roller weighing 1186 gm being careful to apply only roller weight pressure across the sample 12 times (6 in one direction and 6 more orthogonal to the first direction). No wrinkles or creases were allowed. After roughly 90 seconds air pressure was applied. Once the flow was stabilized, the scale was read. This reading was cross referenced with the manufacture supplied correlation table and the air flow was reported in mL/Min.

### Example 1

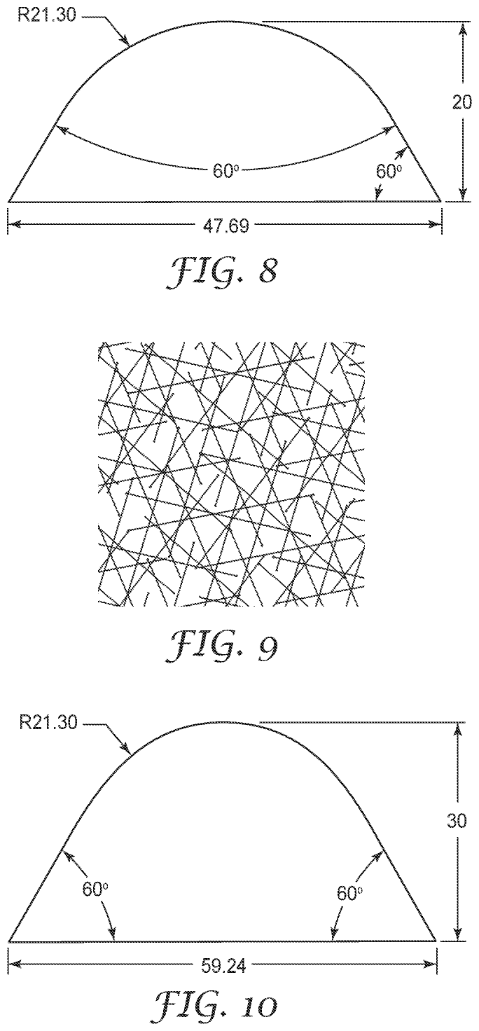

A pattern was embossed into release liner L1 by passing the release liner between a silicone rubber roll and an engraved metal roll. This produced an Irregular Channel Embossed Release Liner. The engraved pattern, was a series of recessed lines (channels) that were pseudo-randomly (irregularly) placed onto the surface of the embossing roll such that the plano-area to total surface area ratio was 85%. For clarity, pseudo-random in this context means patterning that can appear to be random by casual observation, but upon closer observation one would note repeated features. In this case 6 discrete planer orientations (11, 74, 53, 68, 41 and 13 degrees from crossweb orientation) were used for placing the individual lines which were roughly 20 um deep by 50 um wide at the center of the channel tapering to zero in depth and width at the end points. The lines were roughly 3 mm (±0.2mm) long. The taper profile (cross section) was a continuous arch with the maximum depth and width proportion defined by an arch with a 21.3 um radius transitioning to a side wall 60 deg draft angle across a width of 47.7 um. See FIG. 8 for cross section of channel and see FIG. 9 for a layout of the irregular channels.

A pressure sensitive adhesive solution (A1) was slot die coated and dried onto the structured side of the Irregular Channel Embossed Release Liner using a continuous coating/dryer line. This produced an Adhesive Coated Irregular Channel Embossed Release Liner. The drying conditions were a 3 zone ramp (Zone 1=43° C., Zone 2=74° C. and Zone 3=93° C.) with a residence time in each zone of 42 seconds. The exposed adhesive side of the

Adhesive Coated Irregular Channel Embossed Release Liner was laminated at room temperature to film F1 forming an Irregular Channel Structured Adhesive Film. The release liner was removed exposing the negative image pattern from the Irregular Channel Embossed Release Liner in the adhesive surface of the Irregular Channel Structured Adhesive Film. This Irregular Channel Structured Adhesive Film was evaluated using the Test Methods described above.

Results are shown in Table 2, 3 and 4.

### Example 2

Example 2 was generated similarly to that of Example 1, however the target number of channels was increased such that the plano-area to total surface area ratio was designed for 75%.

### Example 3

Example 3 was generated similarly to that of Example 1, however 8 discrete planer orientations (11, 73, 53, 23, 17, 71, 47 and 29 degrees from crossweb orientation) were used for placing the individual lines which were roughly 30 um deep by 60 um wide at the center of the channel tapering to zero in depth and width at the end points. The lines were roughly 4.3 mm (±0.2 mm) long. The taper profile (cross section) was a continuous arch with the maximum depth and width proportion defined by an arch with a 21.3 um radius transitioning to a side wall 60 deg draft angle across a width of 59.2 um. See FIG. 10 for the cross section of the Irregular Channels at their maximum depth.

A pressure sensitive adhesive solution (A1) was then applied to the structured side of the Irregular Channel Embossed Release Liner using a knife-over-bed notched bar coating station having a gap setting of 0.102 mm greater than the thickness of the liner. The liner was pulled through the coating station by hand at approximately 600 centimeters/minute. The coated liner was then dried in a batch oven for 10 minutes at 200 deg. F. After drying, the exposed adhesive side of the Adhesive Coated Irregular Channel Embossed Liner was laminated at room temperature to a film Fl. This was done using a roll 32″ wide laminator from Stoughton Machine and Manufacturing Company (Model Name: Vanquisher) with pressure set at 40 psi (275.8×10\hat{ }4 dynes/cm\hat{ }2) and speed setting at 30 (4.8 cm/sec).

### Example 4

Example 4 was generated similarly to that of Example 3, however the target number of channels was increased such that the plano-area to total surface area ratio was designed for 55%.

### Comparative Examples CE1 and CE2

Comparative Example CE1 was film V1 and Comparative Example 2 was film V2.

TABLE 2

| | | | Ave | |
|---|---|---|---|---|
| | | Adhesive | Adhesive | Adhesive |
| | | Flat Area/ | Channel | Channel |
| | End Points | Total Area | Length | Volume |
| Example | (#/100 mm²) | (%) | (um) | (mm³/100 mm²) |
| Example 1 | 254 | 86% | 3455 | 0.093 |
| Example 2 | 347 | 73% | 3429 | 0.113 |
| Example 3 | 191 | 86% | 4199 | 0.163 |
| Example 4 | 270 | 51% | 3974 | 0.335 |
| CE1 | N/A | 78% | N/A | 0.067 |
| CE2 | N/A | 84% | N/A | 0.111 |

TABLE 3

| | | Back Side Pattern | Backside Pattern |
|---|---|---|---|
| | Dented Panel Trapped | Imprinting | Recognition Test |
| Example | Air Removal (Level) | (Level) | (Pass/Fail) |
| Example 1 | 3 | 0 | Pass |
| Example 2 | 3 | 0 | Pass |
| Example 3 | 1 | 2 | Pass |
| Example 4 | 0 | 2 | Pass |
| CE1 | 3 | 0 | Pass |
| CE2 | 2 | 2 | Fail |

TABLE 4

| | Wet Out Adhesive | Average Wet Out | |
|---|---|---|---|
| | Contact Area | Channel Length | Adhesive Airflow |
| Example | (%) | (um) | (ml/min) |
| Example 1 | 83% | 2411 | 11 |
| Example 2 | 77% | 2653 | 55 |
| Example 3 | 83% | 3276 | 45 |
| Example 4 | 71% | 3176 | 105 |
| CE1 | 81% | N/A | 7 |
| CE2 | 82% | N/A | 41 |

The present invention has now been described with reference to several embodiments thereof. The entire disclosure of any patent or patent application identified herein is hereby incorporated by reference. The foregoing detailed description and examples have been given for clarity of understanding only. No unnecessary limitations are to be understood therefrom. It will be apparent to those skilled in the art that many changes can be made in the embodiments described without departing from the scope of the invention. Thus, the scope of the present invention should not be limited to the structures described herein, but only by the structures described by the language of the claims and the equivalents of those structures.

1-15. (canceled)

16. A film-based article comprising:
a release liner having first and second major sides;
a film layer having first and second major sides;
an adhesive layer disposed between the first major side of the release liner and the second major side of the film, wherein the adhesive layer comprises a first surface adjacent to the second major side of the film, and a second surface adjacent to the first major side of the release liner, and wherein the second surface of the adhesive layer comprises an irregular array of channels,
wherein each channel of the irregular array of channels comprises a channel, wherein the average channel length is less than a length of the adhesive layer and less than a width of the adhesive layer, and wherein the irregular array of channels is formed from discrete channels arranged by a randomization algorithm, wherein each channel has at least one dead end, wherein each channel has a varying channel depth such that the channel depth is relatively shallow proximate each dead end.

17. The film-based article of claim 16, wherein the average channel volume is from 0.163 mm³ to less than 1.0 mm³ per 100 mm² of in-plane adhesive area.

18. The film-based article of claim 16, wherein the first major side of the release liner comprises an irregular array of ridges.

19. The film-based article of claim 16, wherein the film layer comprises at least one of vinyl, polyvinyl chloride, plasticized polyvinyl chloride, polyurethane (PU), polyethylene, polypropylene, fluororesin, polyethylene terephthalate (PET), polyethylene terephthalate glycol (PETG) polymethylmethacrylate (PMMA), polycarbonate (PC), and acrylonitrile butadiene styrene (ABS).

20. The film-based article of claim 16, wherein the second surface of the adhesive layer is in direct contact with the first major side of the release liner.

21. The film-based article of claim 16, wherein the irregular array of channels is arranged to create two dead ends.

22. The film-based article of claim 16, wherein the channel depth is relatively shallow proximate each of the two dead ends.

23. The film-based article of claim 16, wherein the irregular array of channels comprises at least a portion of one dead end per 100 mm² of in-plane adhesive area.

24. The film-based article of claim 16, wherein the cross section of each channel is a continuous arch.

25. The film-based article of claim 24, wherein at least a portion of the continuous arch has a constant radius.
